(19) United States
(12) Patent Application Publication
(10) Pub. No.: US 2016/0341099 A1
(43) Pub. Date: Nov. 24, 2016

(54) INTERNAL COMBUSTION ENGINE

(71) Applicant: TOYOTA JIDOSHA KABUSHIKI KAISHA, Toyota-shi (JP)

(72) Inventors: Shintaro UTSUMI, Susono-shi (JP); Kohei KODAMA, Numazu-shi (JP); Hiroki MURATA, Gotenba-shi (JP)

(73) Assignee: TOYOTA JIDOSHA KABUSHIKI KAISHA, Toyota-shi (JP)

(21) Appl. No.: 15/155,120

(22) Filed: May 16, 2016

(30) Foreign Application Priority Data
May 20, 2015 (JP) 2015-102703

(51) Int. Cl. F01P 3/02; F02D 41/00; F01P 5/12; F02B 31/04; F02M 26/13

(52) U.S. Cl. CPC F01P 3/02; F02B 31/04; F02M 26/13; F01P 5/12; F02D 41/0002; F01P 2003/021; F01P 2003/024; F01P 2003/027; F01P 2005/125; F01P 2005/105

(57) ABSTRACT

An internal combustion engine includes: a low-temperature cooling water circulation system including a low-temperature cooling water channel; a high-temperature cooling water circulation system including a high-temperature cooling water channel; an intake port including a first branch port part and a second branch port part that are connected to a common combustion chamber; and a swirl control device configured to restrict the inflow of intake air from the first branch port part to the combustion chamber to increase the strength of a swirl flow generated inside a cylinder. The low-temperature cooling water channel includes a water jacket that covers the periphery of the first branch port part.

### BACKGROUND

1. Technical Field

Embodiments of the present invention relate to an internal combustion engine, and more particularly to an internal combustion engine which includes a cylinder head having a flow channel where cooling water flows, and in which a swirl flow is generated inside a cylinder.

2. Background Art

Flow channels through which cooling water flow are formed in a cylinder head of an internal combustion engine. Patent Document 1 mentioned below discloses a configuration in which, in order to adequately cool air inside an intake port, a first cooling water circuit through which cooling water for cooling the periphery of the intake port inside a cylinder head circulates is provided independently from a second cooling water circuit through which cooling water for cooling a cylinder block and the periphery of an exhaust port inside the cylinder head circulates.

### LIST OF RELATED ART

Following is a list of patent documents including the above described one which the applicant has noticed as related arts of the present invention.

### Patent Document 1

Japanese Patent Laid-Open No. 2013-133746

### Technical Problem

Operating regions of an internal combustion engine can be identified by engine torque and engine speed. The temperature of intake air suitable for favorable combustion (required intake air temperature) differs depending on the operating region. Because of this, the temperature of cooling water for cooling intake air to satisfy a request for favorable combustion also differs depending on the operating region. During engine operation, the operating region varies momentarily. This may cause a frequent change in the required intake air temperature accompanying a change in the operating region. However, since a temperature adjustment for the cooling water requires time, a response delay becomes a matter when properly adjusting the temperature of the cooling water to address a change in the required intake air temperature.

An internal combustion engine is known that includes a swirl control device that is configured to be capable of strengthening a swirl flow generated inside a cylinder. The presence or absence of a request for strengthening a swirl flow by the swirl control device also differs depending on the operating region. It can be said that a change in a request for strengthening a swirl flow in accordance with the operating region can be promptly addressed by the operation of the swirl control device, as compared with the temperature adjustment for the cooling water. However, in terms of being able to promptly address both changes in a request for strengthening a swirl flow and an intake air cooling request that accompany a change in the operating region, adjusting the cooling water temperature to control intake air is not appropriate due to the reason described above.

### SUMMARY OF THE INVENTION

Embodiments of the present invention address the above-described problem to provide an internal combustion engine which can address both changes in a request for strengthening a swirl flow and an intake air cooling request that accompany a change in an engine operating region, without relying on a temperature adjustment for a cooling water to cool intake air.

An internal combustion engine according to embodiments of the present invention includes: a low-temperature cooling water circulation system that is one of two cooling water circulation systems in which temperatures of cooling water are different, and that includes a low-temperature cooling water channel formed in an internal combustion engine, and that is configured to causes cooling water of a low temperature to circulate in the low-temperature cooling water channel; a high-temperature cooling water circulation system that is one of the two cooling water circulation systems, and that includes a high-temperature cooling water channel formed in the internal combustion engine, and that configured to cause cooling water of a high temperature to circulate in the high-temperature cooling water channel; an intake port including a first branch port part and a second branch port part that are connected to a common combustion chamber; and a swirl control device configured to restrict an inflow of intake air from the first branch port part to the combustion chamber to increase a strength a swirl flow generated inside a cylinder. The low-temperature cooling water channel includes a water jacket that is arranged so as to cover a part of a periphery of the intake port when the intake port is viewed at a cross section that is perpendicular to a central trajectory of the intake port. The water jacket is arranged so that, when the intake port is viewed at the cross section, the water jacket covers a periphery of a region in which an intake air flow rate inside the intake port becomes relatively smaller or a region in which intake air does not flow, when an inflow of intake air to the combustion chamber from the first branch port part is restricted by the swirl control device.

The internal combustion engine may include an exhaust gas recirculation passage through which recirculated exhaust gas that returns from an exhaust passage to an intake passage flows. The exhaust gas recirculation passage may be connected to the second branch port part.

The internal combustion engine may include a blow-by gas return passage through which blow-by gas that returns to an intake passage flows. The blow-by gas return passage may be connected to the second branch port part.

The water jacket may be formed so as to cover a periphery of the first branch port part.

According to embodiments of the present invention, a flow rate of intake air to be cooled by a water jacket can be decreased when an inflow of intake air to a combustion chamber from a first branch port part is restricted by a swirl control device to strength a swirl flow. When, on the other hand, a swirl flow is not strengthened, an inflow of intake air to the combustion chamber from the first branch port part is not restricted by the swirl control device. A large amount of intake air can therefore be cooled by the water jacket as compared with where a swirl flow is strengthened. In this way, embodiments of the present invention can provide an internal combustion engine in which a first control state where a swirl flow is strengthened and intake air cooling is not actively utilized, and a second control state where a swirl flow is not strengthened and intake air cooling is actively utilized can be switched by operation of the swirl control device. Therefore, when selectively using one of the first control state and the second control state in accordance with the engine operating region, embodiments of the present invention can promptly address both changes in a request for strengthening a swirl flow and an intake air cooling request that accompany a change in the engine operating region, without relying on a temperature adjustment for a cooling water to cool intake air.

### BRIEF DESCRIPTION OF THE DRAWINGS

FIG. 1 is a schematic diagram illustrating a system configuration of an engine according to the first embodiment of the present invention;

FIG. 2 is a cross-sectional diagram of a cylinder head that is cut along a line A-A shown in FIG. 1;

FIG. 3 is a perspective view in which intake ports and a first LT cooling water channel shown in FIG. 1 are illustrated in a transparent manner from above the intake side;

FIG. 4 is a perspective view in which the intake ports and the first LT cooling water channel shown in FIG. 1 are illustrated in a transparent manner from the upstream side of the flow of intake air inside branch port parts of the intake ports;

FIG. 5 is a schematic view illustrating the configuration around the intake port according to the first embodiment;

FIG. 6A through FIG. 6C are graphs for explaining requests with respect to each operating region of the engine;

FIG. 7 is a schematic view for describing a configuration around the intake port according to a second embodiment of the present invention;

FIG. 8 is a view for describing another example of a region in which a water jacket that covers a periphery of the first branch port part is arranged;

FIG. 9 is a view for describing yet another example of a region in which a water jacket that covers a periphery of the first branch port part is arranged;

FIG. 10 is a view for describing still another example of a region in which a water jacket that covers a periphery of the first branch port part is arranged;

FIG. 11 is a perspective view that schematically illustrates another configuration example of an SCV in the present application; and

FIG. 12 is a view for describing a region in which a water jacket that covers a periphery of the intake port in an engine shown in FIG. 11 is arranged.

### DETAILED DESCRIPTION

Embodiments of the present invention will now be described referring to the accompanying drawings. However, the embodiments described hereunder exemplify an apparatus or a method for materializing the technical concept of the present application, and except where otherwise expressly stated, it is not intended to limit the structures and arrangements of the constituent components and the order of processes and the like to those described hereunder. The present application is not limited to the embodiments described hereunder, and various modifications can be made within a range that does not depart from the gist of the present application.

### First Embodiment

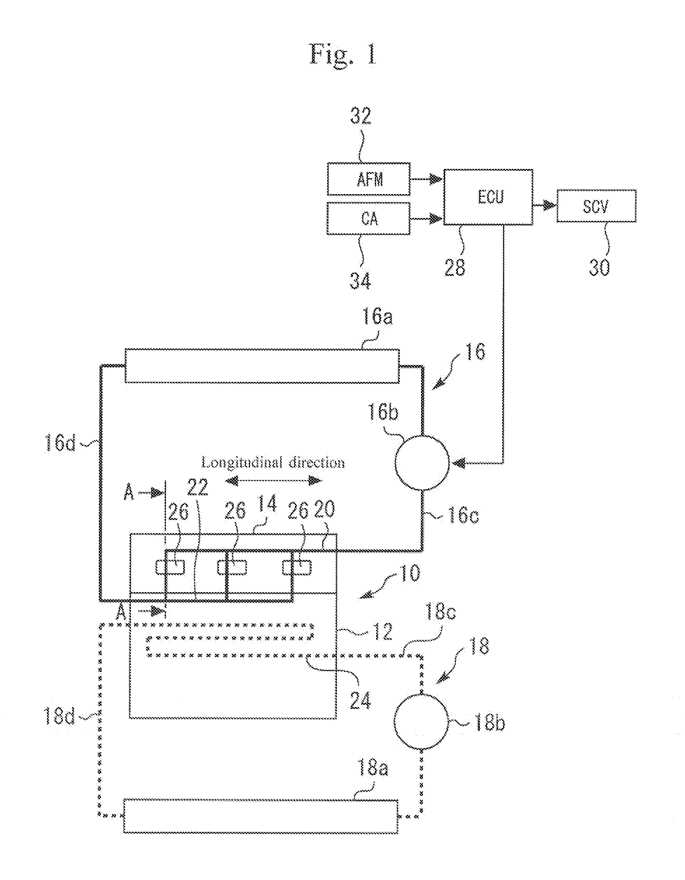

Hereunder, a first embodiment of the present invention is described using FIG. 1 to FIG. 6. The description of the first embodiment is based on the premise that the internal combustion engine (hereunder, abbreviated as “engine”) is a spark-ignition type, water-cooled inline three-cylinder engine. This premise also applies to a second embodiment and the like that are described later. However, the number of cylinders, the layout of cylinders, and the type of ignition of an engine according to the present application is not particularly limited. Further, cooling water for cooling the engine is circulated between the engine and a radiator by a circulation system. Cooling water is supplied to both of the cylinder block and the cylinder head.

### [System Configuration of Engine]

The system configuration of an engine 10 according to the first embodiment of the present invention will be described referring to FIG. 1. The engine (internal combustion engine) 10 shown in FIG. 1 includes a cylinder block 12, and a cylinder head 14 that is mounted on the cylinder block 12 via an unshown gasket.

An engine cooling system of the first embodiment includes two cooling water circulation systems 16 and 18. Each of the two cooling water circulation systems 16 and 18 is an independent closed loop, and the temperatures of the cooling water circulated through the respective circulation systems can be made to differ from each other. Hereunder, the cooling water circulation system 16 in which cooling water of a relatively low temperature circulates is referred to as an “LT cooling water circulation system”, and the cooling water circulation system 18 in which cooling water of a relatively high temperature circulates is referred to as an “HT cooling water circulation system”. The HT cooling water circulation system 18 is responsible for the principal cooling of the cylinder block 12. On the other hand, the LT cooling water circulation system 16 is mainly responsible for cooling of an intake port 26 for which a cooling load is small in comparison to the cylinder block 12. Note that, “LT” is an abbreviation of “low temperature” and “HT” is an abbreviation of “high temperature”. Further, the engine cooling system may include an unshown water temperature sensor or a thermostat for regulating the water temperature.

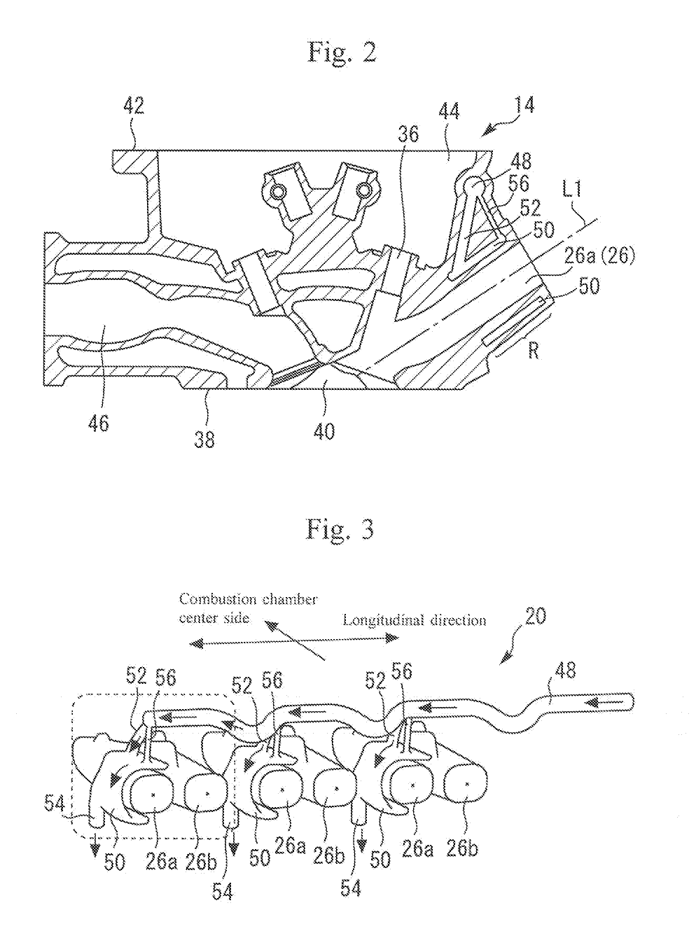

The LT cooling water circulation system 16 includes a first LT cooling water channel 20 that is formed inside the cylinder head 14, and a second LT cooling water channel 22 that is formed inside the cylinder block 12. A cooling water inlet that communicates with the first LT cooling water channel 20 is formed in the cylinder head 14. The first LT cooling water channel 20 of the cylinder head 14 and the second LT cooling water channel 22 of the cylinder block 12 are connected through an opening formed in an abutting surface 38 (see FIG. 2) between the cylinder head 14 and the cylinder block 12. A cooling water outlet of the second LT cooling water channel 22 is formed in the cylinder block 12. The cooling water inlet of the cylinder head 14 is connected to a cooling water outlet of an LT radiator 16a via an LT cooling water introduction pipe 16c. A cooling water outlet of the cylinder block 12 is connected to a cooling water inlet of the LT radiator 16a via a cooling water discharge pipe 16d. An LT water pump 16b is provided in the LT cooling water introduction pipe 16c.

The HT cooling water circulation system 18 includes an HT cooling water channel 24 that is formed inside the cylinder block 12. The HT cooling water channel 24 of the cylinder block 12 includes a water jacket that covers a periphery of each cylinder. A cooling water inlet and a cooling water outlet that are connected to the HT cooling water channel 24 are also formed in the cylinder block 12. The cooling water inlet of the HT cooling water channel 24 is connected to a cooling water outlet of an HT radiator 18a via an HT cooling water introduction pipe 18c. The cooling water outlet of the HT cooling water channel 24 is connected to a cooling water inlet of the HT radiator 18 via an HT cooling water discharge pipe 18d. An HT water pump 18b is provided in the HT cooling water introduction pipe 18c.

An intake port 26 that is one part of an intake passage of the engine 10 is formed for each cylinder in the cylinder head 14. The arrangement of the first LT cooling water channel 20 around the intake port 26 will be described in detail later referring to FIGS. 2 to 5.

As one example, the LT water pump 16b is an electric motor-driven water pump. Further, as one example, the HT water pump 18b is a water pump that is driven by the torque of a crankshaft (not illustrated in the drawings). The LT water pump 16b is electrically connected to an electronic control unit (ECU) 28, and is driven in accordance with commands from the ECU 28. The ECU 28 includes at least an input/output interface, a memory and a central processing unit (CPU), and performs control of not only the above described cooling system, but also of the entire system of the engine 10.

Various actuators for controlling operation of the engine 10, such as an electric motor 64 (see FIG. 5) for rotationally driving a swirl control valve (SCV) 30 for controlling the strength of a swirl flow inside a cylinder are connected to the ECU 28. The SCV 30 is described in detail later referring to FIG. 5. In addition, various sensors for detecting the operating state of the engine 10, such as an air flow meter (AFM) 32 that measures an intake air flow rate, and a crank angle sensor (CA) 34 for acquiring the engine speed are connected to the ECU 28.

### [Internal Configuration of Cylinder Head]

FIG. 2 is a cross-sectional diagram of the cylinder head 14 that is cut along a line A-A shown in FIG. 1. In the present specification, as shown in FIG. 1, the axial direction of the crankshaft is defined as the longitudinal direction of the cylinder head 14. The A-A cross-section of the cylinder head 14 is a cross-section that includes a central axis of an intake valve insertion hole 36 of the cylinder head 14, and that is perpendicular to the longitudinal direction. Reference character L1 shown in FIG. 2 denotes a central trajectory of the intake port 26.

As shown in FIG. 2, a combustion chamber 40 having a pent-roof shape is formed in the cylinder block abutting surface 38 that corresponds to the underside of the cylinder head 14. When the cylinder head 14 is assembled to the cylinder block 12, the combustion chamber 40 blocks off the cylinder from the upper side to constitute a closed space. Note that, because the engine 10 is an inline three-cylinder engine, three combustion chambers 40 that correspond to three cylinders are formed side by side at even intervals in the longitudinal direction of the cylinder head 14.

The intake port 26 is open in one inclined face (roof) of the combustion chamber 40. The interfaces between the intake port 26 and the combustion chamber 40, that is, opening ends on the combustion chamber side (outlet side) of the intake port 26 are intake openings that are opened and closed by the respective intake valves 58 (see FIG. 5). Since two of the intake valves 58 are provided for each cylinder, two intake openings of the intake port 26 are formed in the combustion chamber 40. An inlet of the intake port 26 is open in one side face of the cylinder head 14.

A flow channel for intake air inside the intake port 26 branches into two parts at a position that is partway along the flow channel. Here, the branched parts of the intake port 26 are referred to as a “first branch port part 26a” and a “second branch port part 26b”. The first branch port part 26a and the second branch port part 26b are arranged side by side in the longitudinal direction of the cylinder head 14, and the branch port parts are connected to the respective intake opening formed in the common combustion chamber 40. The first branch port portion 26a is illustrated in FIG. 2. The above described SCV 30 (see FIG. 5) is arranged in the first branch port part 26a and is configured to open and close a flow channel in the first branch port part 26a.

An intake valve insertion hole 36 is formed in the cylinder head 14 to allow a stem of the intake valve 58 to pass through. An intake-side valve train chamber 44 that houses a valve train that actuates the intake valves 58 is provided on the inner side of a head cover mounting face 42 that is a part of the upper face of the cylinder head 14. Note that, an exhaust port 46 opens in another inclined face (roof) of the combustion chamber 40. The interfaces between the exhaust port 46 and the combustion chamber 40, that is, opening ends on the combustion chamber side of the exhaust port 46 are exhaust openings that are opened and closed by the respective exhaust valve 60 (see FIG. 5).

### [Configuration of LT Cooling Water Channel in Cylinder Head]

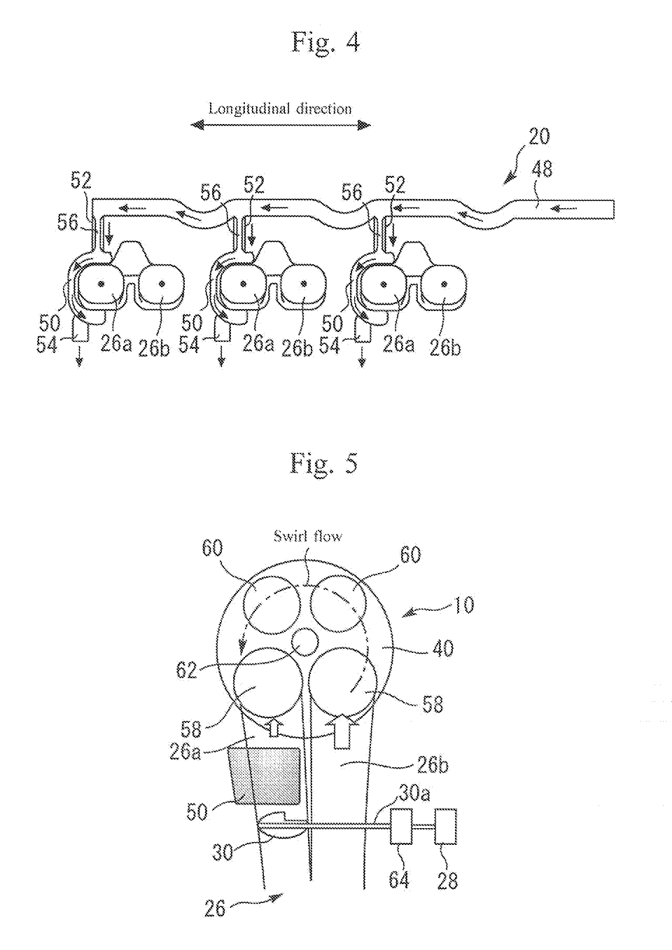

FIG. 3 is a perspective view in which the intake ports 26 and the first LT cooling water channel 20 shown in FIG. 1 are illustrated in a transparent manner from above the intake side. FIG. 4 is a perspective view in which the intake ports 26 and the first LT cooling water channel 20 shown in FIG. 1 are illustrated in a transparent manner from the upstream side of the flow of intake air inside the branch port parts 26a and 26b of the intake ports 26. In FIG. 3 and FIG. 4, the shape of the first LT cooling water channel 20 when the inside of the cylinder head 14 is viewed in a transparent manner, and the positional relation between the first LT cooling water channel 20 and the branch port parts 26a and 26b are illustrated. Note that, arrows in these diagrams represent the direction of the flow of cooling water.

The first LT cooling water channel 20 is configured to supply LT cooling water to the periphery of the first branch port part 26a of each cylinder in the cylinder head 14. More specifically, the first LT cooling water channel 20 includes a main flow channel 48. The main flow channel 48 extends in the direction of the row of intake ports 26 (that is, longitudinal direction of the cylinder head 14), at a position above the row of intake ports 26.

One end of the main flow channel 48 is open at a cooling water inlet of the cylinder head 14. Further, as shown in FIG. 2, the main flow channel 48 is provided so as to be located on the upper side of the intake ports 26 when it is assumed that the cylinder head 14 is positioned on the upper side in the vertical direction with respect to the cylinder block 12. That is, the main flow channel 48 is arranged at a location sufficiently separated from the cylinder block abutting surface 38. Consequently, reception of heat from the cylinder block abutting surface 38 by LT cooling water inside the main flow channel 48 is suppressed. This is preferable in terms of introducing low-temperature cooling water into a water jacket 50 of each intake port 26 from the main flow channel 48.

The first LT cooling water channel 20 has a unit structure for each intake port 26. In FIG. 3, the structure of a section surrounded by a dashed line is the unit structure of the first LT cooling water channel 20. The unit structure includes the water jacket 50 that is arranged at the periphery of the first branch port part 26a. Reference character R in FIG. 2 denotes a region in which the water jacket 50 is formed in a direction along the central trajectory L1 of the intake port 26 (flow channel extension direction). When the intake port 26 is viewed at a cross-section that is perpendicular to the central trajectory L1 of the intake port 26 (cross-section perpendicular to the flow channel extension direction of the intake port 26), inside the region R the water jacket 50 is formed so as to cover the periphery of the first branch port part 26a without covering the periphery of the second branch port part 26b.

Each water jacket 50 is connected to the main flow channel 48 through a branch flow channel 52. A connecting path 54 that communicates with the second LT cooling water channel 22 formed inside the cylinder block 12 is connected to each water jacket 50. That is, each water jacket 50 is open in the cylinder block abutting surface 38 through the corresponding connecting path 54.

Further, the first LT cooling water channel 20 includes an auxiliary flow channel 56 that connects the water jacket 50 and the main flow channel 48. The auxiliary flow channel 56 is a flow channel that serves a purpose as an air vent inside the water jacket 50, and is provided in a direction towards the main flow channel 48 from a top part in the vertical direction of the water jacket 50. Note that, the auxiliary flow channel 56 is configured as a flow channel in which the channel cross-sectional area is smaller than that of the branch flow channel 52.

According to the configuration illustrated in FIG. 3 and FIG. 4, LT cooling water that is cooled by the LT radiator 16a is introduced into the main flow channel 48. The LT cooling water introduced into the main flow channel 48 is guided in parallel to the water jackets 50 of the respective cylinders through the branch flow channels 52. The LT cooling water that is introduced to the respective water jackets 50 from the main flow channel 48 circulates along the periphery of the corresponding first branch port part 26a, and thereafter is discharged through the connecting path 54 to the second LT cooling water channel 22 of the cylinder block 12. According to the present configuration, the first branch port part 26a can be cooled by LT cooling water while ensuring that the second branch port part 26b is not cooled by the LT cooling water. That is, according to the present configuration, the intensity of cooling can be varied between the first branch port part 26a and the second branch port part 26b. Further, by cooling the wall surface of the first branch port part 26a by means of the LT cooling water, intake air that flows through the first branch port part 26a can be cooled.

### [Configuration Around Intake Port]

FIG. 5 is a schematic view illustrating the configuration around the intake port 26 according to the first embodiment. Note that, in FIG. 5, reference numeral 58 denotes an intake valve, reference numeral 60 denotes an exhaust valve, and reference numeral 62 denotes a spark plug.

The SCV 30 is arranged inside the first branch port part 26a. A rotary shaft 30a of the SCV 30 is connected to the electric motor 64. According to this configuration, the SCV 30 can be rotationally driven by means of the electric motor 64. In one example shown in FIG. 5, the water jacket 50 is formed so as to cover the periphery of the first branch port part 26a at a location on the downstream side of the SCV 30.

If the SCV 30 is closed, an inflow of intake air to the combustion chamber 40 from the first branch port part 26a is restricted. As a result of this, a deviation is generated between the respective intake air flow rates (mass flow rate) of the first branch port part 26a and the second branch port part 26b. More specifically, the deviation is generated in a form such that the intake air flow rate inside the first branch port part 26a becomes smaller in comparison to the intake air flow rate inside the second branch port part 26b. Accordingly, it can be said that the water jacket 50 for cooling intake air is not provided at the second branch port part 26b that corresponds to a region in which the intake air flow rate becomes relatively larger when a deviation between the intake air flow rates within the intake port 26 is generated by means of the SCV 30, and the water jacket 50 is provided at the first branch port part 26a that corresponds to a region in which the intake air flow rate becomes relatively smaller. Note that, if the SCV 30 is simply closed, the flow rate of air that flows into the cylinder will decrease. Therefore, when the SCV 30 is closed, an operation that opens a throttle valve (not illustrated in the drawings) for ensuring that the flow rate of air does not decrease is executed in a coordinated manner therewith.

When a deviation between the intake air flow rates within the intake port 26 is generated by means of the SCV 30, a swirl flow generated in the cylinder is strengthened. According to the configuration of the present embodiment, the water jacket 50 is provided for the first branch port part 26a on the side on which the inflow of intake air is restricted when strengthening a swirl flow. Therefore, when the SCV 30 is closed and the swirl flow is strengthened, a large portion of the intake air that is introduced into the combustion chamber 40 can be prevented from being cooled. On the other hand, when the SCV 30 is opened (that is, when strengthening of a swirl flow is not required), an inflow of intake air to the combustion chamber 40 from the first branch port part 26a is not restricted, and intake air that is cooled using the water jacket 50 can therefore be introduced into the combustion chamber 40.

Note that, when the SCV is fully closed and the first branch port part is completely blocked in order to strengthen the swirl flow, an inflow of intake air from the first branch port part to the combustion chamber is stopped. Strengthening of a swirl flow in the present application may also be realized by restricting the inflow of intake air from the first branch port part to the combustion chamber in a manner that stops the inflow of intake air from the first branch port part to the combustion chamber in this way. In this example, a flow of intake air does not arise within the first branch port part when a deviation is generated between the respective intake air flow rates. Accordingly, the first branch port part that is a region in which intake air does not flow corresponds to a region in which a water jacket is provided in the aforementioned example.

### Advantages of Configuration According to First Embodiment

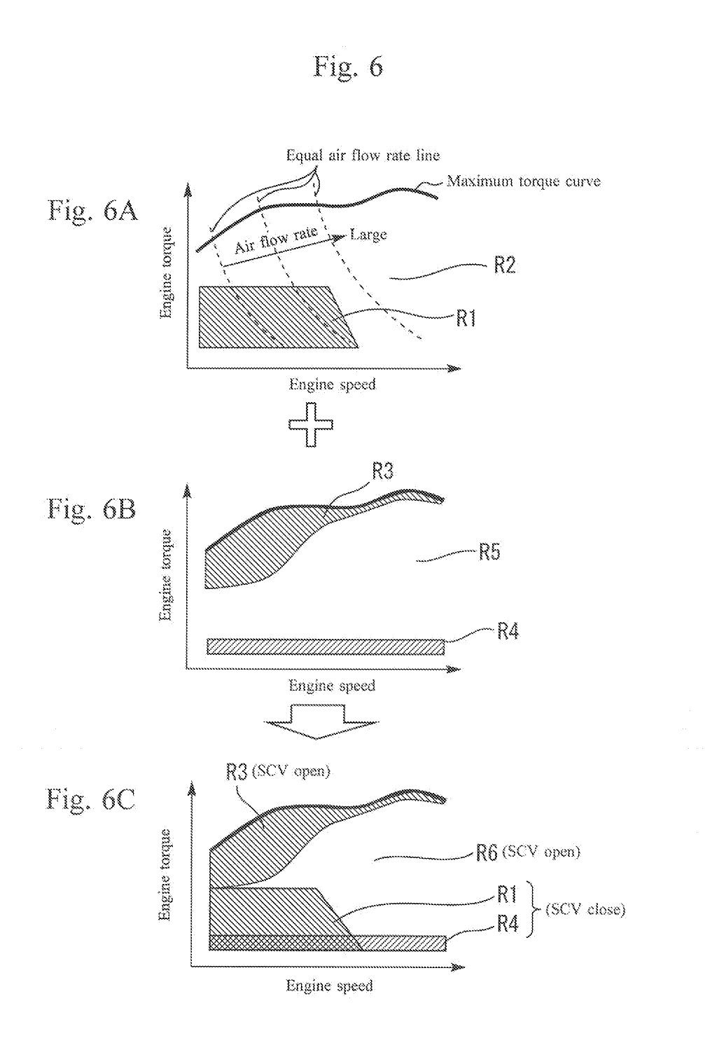

FIG. 6A through FIG. 6C are graphs for explaining requests with respect to each operating region of the internal combustion engine 10. The operating regions shown in FIG. 6A through FIG. 6C are identified by the engine torque and the engine speed. In some engines including the engine 10 in which an operation is performed under the stoichiometric air-fuel ratio, the following requests are present.

FIG. 6A represents engine operating regions in terms of a request for strengthening a swirl flow. A region R1 indicated by hatching in FIG. 6A represents an operating region in which a request for strengthening a swirl flow (a request for closing the SCV 30) is present. The region R1 is a low and medium speed region and a low and medium load region in which the flow velocity of intake air is not sufficiently high since the intake air flow rate is not large. In such region R1, strengthening of a swirl flow is required to improve the efficiency and stability of combustion by strengthening turbulence of the gas in a cylinder.

On the other hand, a region R2 indicated without hatching in FIG. 6A represents an operating region on the high-speed or the high-load side relative to the region R1. In the region R2, strengthening of a swirl flow is not required due to a larger air flow rate relative to the region R1, and is conversely required to open the SCV 30 to reduce intake air resistance.

FIG. 6B represents engine operating regions in terms of an intake air cooling request. A region shown indicated by hatching in FIG. 6B includes a region R3 and a region R4. The region R3 is an operating region on the high-load side (especially, low-speed and high-load region) in which there is a concern of occurrence of a knocking. In the region R3, intake air cooling is required to suppress occurrence of a knocking. The region R4 corresponds to an operating region in which intake air cooling is not allowed for ensuring the stability of combustion. On the other hand, a region R5 indicated without hatching in FIG. 6B is a non-knocking region and an operating region in which intake air cooling is not required (more specifically, an operating region in which whether intake air cooling is required or not is left unquestioned).

FIG. 6C represents engine operating regions which are obtained by overlapping the regions shown in FIG. 6A and the regions shown in FIG. 6B. Consideration of both of a request for strengthening a swirl flow and an intake air cooling request reveals the following. That is, first, it is found that, as shown in FIG. 6C, a part of the region R1 in which strengthening of a swirl flow is required and a part of the region R4 in which intake air cooling is not allowed for ensuring the stability of combustion are overlapped with each other. For these regions R1 and R4, according to the configuration in the present embodiment, both of a request for strengthening a swirl flow and a request according to which intake air cooling is not required or not allowed can be satisfied by closing the SCV 30.

Moreover, it is found from FIG. 6C that the regions R1 and R4, in which closing of the SCV 30 is preferred as described above, and the region R3, in which strengthening of a swirl flow is not required (that is, opening of the SCV 30 is preferred) and intake air cooling is necessary, are not overlapped. Furthermore, a region R6 shown in FIG. 6C is an operating region other than the regions R1, R3 and R4. In the region R6, strengthening of a swirl flow is not required (that is, opening of the SCV 30 is preferred), and intake air cooling is not required (more specifically, whether the intake air cooling is required or not is left unquestioned).

Based on the foregoing facts, it can be said that all requests for the respective regions shown in FIG. 6C can be satisfied by closing the SCV 30 in the regions R1 and R4 and opening the SCV 30 in the regions R3 and R6. The ECU 28 is configured to open and close the SCV 30 with the aforementioned manner based on the engine operating region. Note that acquisition of the current operating region to determine a control position of the SCV 30 can be done, for example, using an engine torque that is calculated based on an intake air flow rate measured by the air flow sensor 32 and an engine speed that is calculated based on detection values of the crank angle sensor 34.

During engine operation, the engine operating region varies momentarily. Because of this, the presence or absence of a request for strengthening a swirl flow and the presence or absence of an intake air cooling request may be changed frequently during engine operation. Control of a swirl control device such as the SCV 30 can promptly address a change in the presence or absence of a request for strengthening a swirl flow. However, concerning a change in the presence or absence of an intake air cooling request, a response delay becomes a matter if an attempt to address the change by adjusting the cooling water temperature is made. More specifically, when the temperature of intake air is controlled using the adjustment of the cooling water temperature, the temperature of a wall of the intake port changes as a result of a change in the cooling water temperature, and then the temperature of the intake air changes. In this process, responsiveness of a change in the actual temperature of the cooling water with respect to a predetermined operation for adjusting the cooling water temperature is not good. Accordingly, in order to address a change in the presence or absence of an intake air cooling request accompanying a frequent change in the operating region it is assumed to be difficult for the adjustment of the cooling water temperature to promptly control the temperature of intake air. If the temperature of intake air cannot be promptly controlled when the operating region changes transiently, it is required, for example, to retard the ignition timing for suppressing occurrence of a knocking. This leads to cause a deterioration of the fuel efficiency of the engine, and to lengthen a time required for acceleration because of a decrease in the engine torque at the time of the acceleration.

In contrast, according to the configuration of the present embodiment, in a state in which the SCV 30 is opened, intake air in the first branch port part 26a that is cooled by the water jacket 50 can be supplied to the combustion chamber 40 while a swirl flow is not strengthened. On the other hand, in a state in which the SCV 30 is closed, a swirl flow can be strengthened mainly using intake air in the second branch port 26b that is not cooled by the water jacket 50, and the present configuration can also address a request according to which intake air cooling is not allowed. In this way, the present configuration can address a frequent change in the presence or absence of an intake air cooling request without a large delay in time because this configuration does not relay on a temperature adjustment for the LT cooling water. Thus, even when the operating region changes transiently, more favorable combustion can be obtained since, for example, the retard of the ignition timing is suppressed. As a result, the fuel efficiency can be improved and a time required for acceleration can be shortened.

Moreover, in some engines, control to decrease pumping loss may be performed in which the valve timing of an intake valve is adjusted by a variable valve timing device so that blowback of intake air into an intake port occurs actively at the time of opening or closing the intake valve and in which the opening degree of a throttle valve is adjusted to the open side. Such control is effective in a low and medium load region, and therefore, an operating region in which this control is performed may overlap with the region R1 where a request for strengthening a swirl flow is present. If such control is applied to the engine 10 of the present embodiment, the amount of intake air blown back into each branch port part 26a and 26b is larger in the second branch port part 26b in which its flow channel is not narrowed by the SCV 30 than in the first branch port part 26a in which the SCV 30 is closed for strengthening a swirl flow. The intake air blown back contains a residual gas component (burned gas component) in a cylinder. Therefore, if intake air is blown back into a region the channel wall surface of which is cooled in the intake port, deposition of the gas component readily occurs. According to the configuration in the present embodiment, the amount of intake air blown back is larger in the second branch port part 26b that is not taken as an object of cooling by the water jacket 50 than in the first branch port part 26a. Therefore, the present configuration can utilize a swirl flow while suppressing the deposition due to blowback of intake air.

Note that, in the above described first embodiment, the first LT cooling water channel 20 corresponds to a “low-temperature cooling water channel” according to the present application, the LT cooling water circulation system 16 corresponds to a “low-temperature cooling water circulation system” according to the present application, the HT cooling water channel 24 corresponds to a “high-temperature cooling water channel” according to the present application, and the HT cooling water circulation system 18 corresponds to a “high-temperature cooling water circulation system” according to the present application.

### Second Embodiment

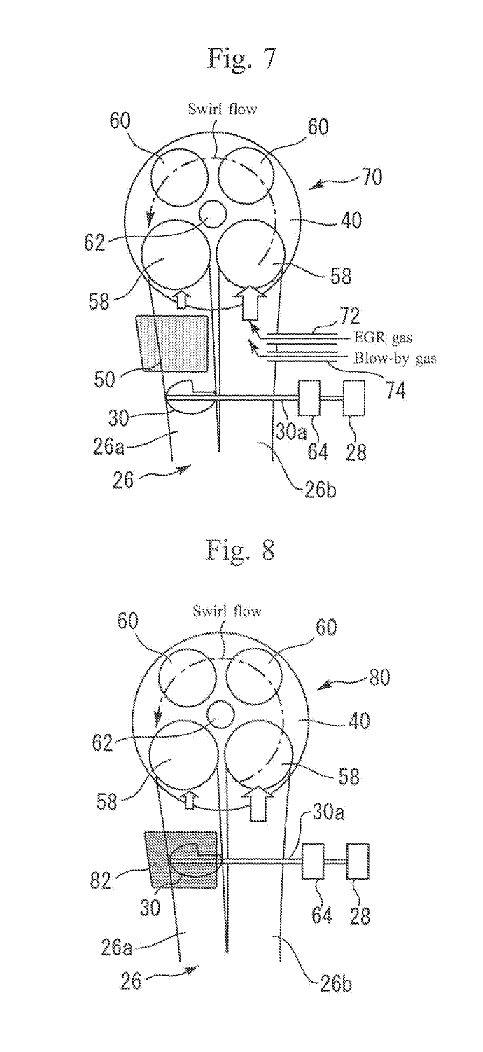

Next, a second embodiment of the present invention will be described by newly referring to FIG. 7. An internal combustion engine 70 of the present embodiment has the same configuration as the engine 10 of the first embodiment with the exception that the configuration described hereunder referring to FIG. 7 is added to the engine 70 of the present embodiment. Note that the configuration of the present embodiment may also be implemented in combination with the configurations illustrated in FIG. 8 through FIG. 12 that are described later.

FIG. 7 is a schematic view for describing a configuration around the intake port 26 according to the second embodiment of the present invention. In the engine 70 illustrated in FIG. 7, an exhaust gas recirculation (EGR) passage 72 and a blow-by gas return passage 74 are connected to the second branch port part 26b. The EGR passage 72 is a passage through which recirculated exhaust gas (EGR gas) that returns to the intake passage from the exhaust passage flows. The blow-by gas return passage 74 is a passage for causing blow-by gas to return to the intake passage. Note that although the engine 70 in which both of the EGR passage 72 and the blow-by gas return passage 74 are connected to the second branch port part 26b has been described here, a configuration may also be adopted in which a passage connected to the second branch port part 26b is either one of the EGR passage 72 and the blow-by gas return passage 74.

The second branch port part 26b that is a part to which the EGR passage 72 and the blow-by gas return passage 74 are connected corresponds to a branch port part on the side on which the SCV 30 is not provided, that is, a branch port part on the side that is not taken as an object of cooling because the side is not covered by the water jacket 50.

If the configuration is such that EGR gas or blow-by gas introduced into the intake passage flows through a region in which the wall surface is cooled, deposition of matter contained in the gas readily occurs on the cooled wall surface. The reason is that it is difficult for moisture or oil included in the EGR gas or blow-by gas to evaporate when adhered to the cooled passage wall surface.

In contrast, in the engine 70 of the present embodiment, as described above, the EGR passage 72 and the blow-by gas return passage 74 are connected to the second branch port part 26b on the side that is not taken as an object of cooling by the water jacket 50. According to this configuration, the deposition, on the passage wall surface, of EGR gas or blow-by gas introduced into the intake passage as a result of adhesion of EGR gas or blow-by gas thereto can be suppressed.

### Other Embodiments

In the foregoing first and second embodiments, as shown in FIG. 5, the water jacket 50 for cooling the intake port 26 is formed so as to cover a periphery of the first branch port part 26a on the downstream side of the SCV 30. However, a region in which a water jacket that covers a periphery of the first branch port part 26a is arranged may be ones described with reference to FIG. 8 through FIG. 10 hereunder.

FIG. 8 is a view for describing another example of a region in which a water jacket that covers a periphery of the first branch port part 26a is arranged. A water jacket 82 which an engine 80 shown in FIG. 8 includes is formed so as to cover a periphery of the first brank port part 26a in a manner such that the water jacket 82 extends around each region on the upstream and downstream side of the SCV 30 (that is, in a manner so as to cross the SCV 30).

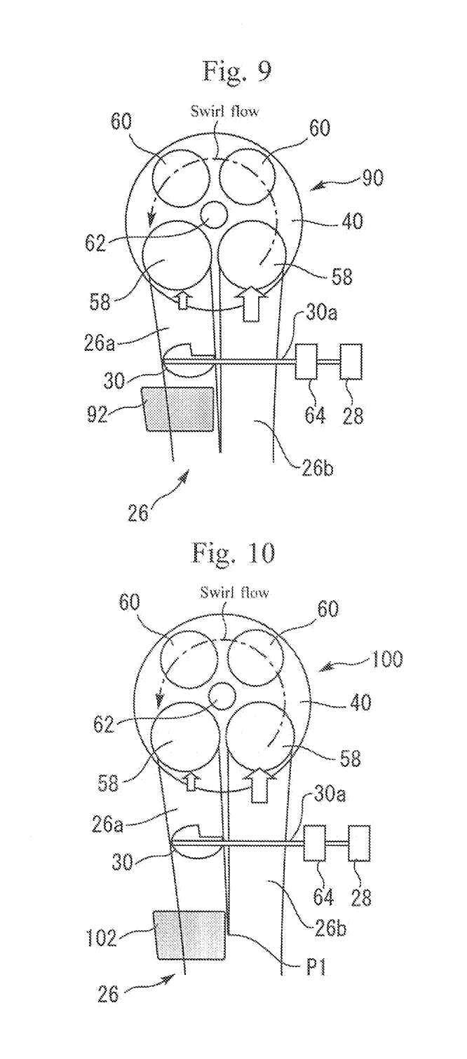

FIG. 9 is a view for describing yet another example of a region in which a water jacket that covers a periphery of the first branch port part 26a is arranged. A water jacket 92 which an engine 90 shown in FIG. 9 includes is formed so as to cover a periphery of the first brank port part 26a on the upstream side of the SCV 30. As already described in the first embodiment, if intake air may be blown back when the SCV 30 is closed to strengthen a swirl flow, it is preferable that, as with the water jacket 92 in the present configuration, a water jacket be arranged on the upstream side of the SCV 30. If a water jacket is arranged on the upstream side of the SCV 30, it is possible to make it difficult for intake air that is blown back into the first branch port part 26a to be cooled as compared with an example in which the water jacket is arranged on the downstream side of the SCV 30. The deposition at the first branch port part 26a can therefore be suppressed. This similarly applies with respect to the following configuration shown in FIG. 10.

FIG. 10 is a view for describing still another example of a region in which a water jacket that covers a periphery of the first branch port part 26a is arranged. Reference character P1 in FIG. 10 indicates a branch point where the first branch port part 26a and the second branch port part 26b branch. A water jacket 102 which an engine 100 shown in FIG. 10 includes is formed so as to cover a periphery of the first branch port part 26a on the upstream side of the SCV 30, as with the water jacket 92 shown in FIG. 9. A difference between the water jacket 102 and the water jacket 92 is that a region in which the water jacket 102 is arranged includes a region of the intake port 26 on the upstream side of the branch point P1. As with this example, a water jacket for a configuration in which the SCV 30 is arranged in the first branch port part 26a may be formed so as to extend to the upstream side of the branch point P1. However, if such a water jacket extends to the upstream side of the branch point P1 too long, intake air that flows toward the second branch port part 26b from the upstream of the first branch port part 26a accompanying the closing of the SCV 30 will be cooled by the water jacket. Therefore, if a water jacket is formed so as to extend to the upstream side of the branch point P1, it is required to take into consideration that intake air toward the second branch port part 26b from the upstream of the first branch port part 26a is not cooled when the SCV 30 is closed.

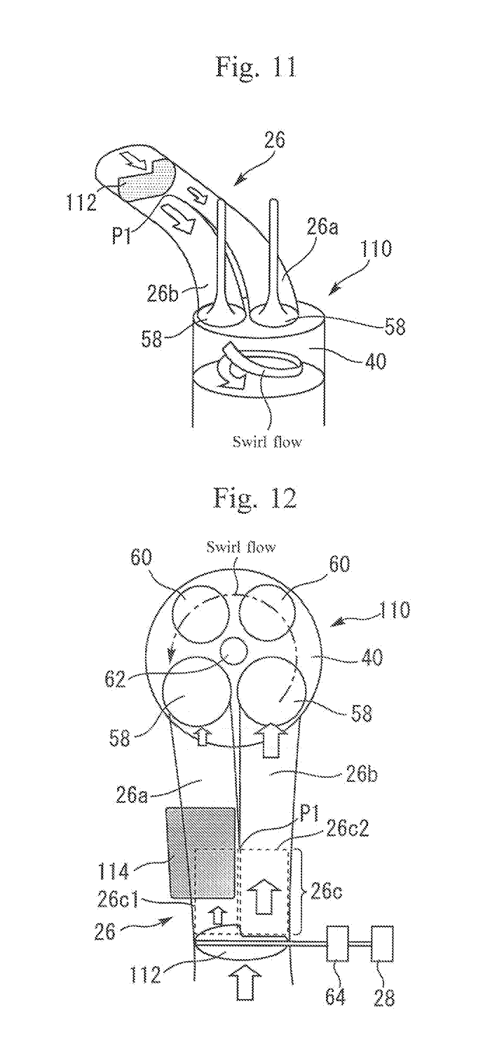

The foregoing first and second embodiments have been described taking a configuration in which the SCV 30 is arranged inside the first branch port part 26a as an example. However, a region in which the SCV that is an object of the present application is arranged may be a region described hereunder that is illustrated in FIG. 11. Further, for an engine that includes the configuration illustrated in FIG. 11, a water jacket that cools some of the periphery of the intake port 26 may, for example, be a water jacket illustrated in FIG. 12.

FIG. 11 is a perspective view that schematically illustrates another configuration example of an SCV in the present application. An SCV 112 that an engine 110 shown in FIG. 11 includes is not arranged in the first branch port part 26a, but rather is arranged in the intake port 26 on the upstream side of a branch point P1 that is a point at which the first branch port part 26a and the second branch port part 26b branch. As shown in FIG. 11, in the SCV 112, a part on the side corresponding to the second branch port part 26b is notched. Consequently, when the SCV 112 is closed, an inflow of intake air from the first branch port part 26a to the combustion chamber 40 is restricted. As a result, in an example where the SCV 112 is provided, similarly to an example where the above described SCV 30 is provided, a deviation can be generated between the intake air flow rates of the first branch port part 26a and the second branch port part 26b.

FIG. 12 is a view for describing a region in which a water jacket 114 that covers a periphery of the intake port 26 in the engine 110 shown in FIG. 11 is arranged. A deviation between the intake air flow rates is also generated in a manner such that the intake air flow rate inside the first branch port part 26a becomes less than the intake air flow rate inside the second branch port part 26b by means of the SCV 112. Further, in the present configuration, a deviation between the intake air flow rates is also generated in a flow channel 26c in a section from the position of the SCV 112 to the branch point P1. Accordingly, the water jacket 114 is formed so as to cover the periphery of the intake port 26 on the downstream side of the SCV 112, which includes the first branch port part 26a, in the direction of the flow of intake air inside the intake port 26 (i.e. the extension direction of the intake port 26).

In a situation in which a deviation is generated between the intake air flow rates inside the intake port 26 by the SCV 112 (that is, the situation illustrated in FIG. 12), with regard to the flow channel 26c in the section from the position of the SCV 112 to the branch point P1, a region 26c1 that is located upstream of the first branch port part 26a corresponds to a region in which the intake air flow rate becomes relatively smaller, and a region 26c2 that is located upstream of the second branch port part 26b corresponds to a region in which the intake air flow rate becomes relatively larger. Further, under the above described circumstances, with regard to the branched intake port 26, the first branch port part 26a corresponds to a region in which the intake air flow rate becomes relatively smaller, and the second branch port part 26b corresponds to a region in which the intake air flow rate becomes relatively larger. Therefore, a region in which the water jacket 114 is arranged is defined as follows when the region is viewed at a cross-section that is perpendicular to the central trajectory of the intake port 26 (cross-section perpendicular to the extension direction of the intake port 26). That is, the water jacket 114 is formed so as to cover a part of the periphery of the first branch port part 26a and a part of the periphery of the aforementioned region 26c1 that corresponds to a region of the intake port 26 on the side on which the intake air flow rate becomes relatively smaller in a situation in which the above described deviation is generated.

Note that, in the configuration shown in FIG. 12, the water jacket 114 is provided with respect to both of the first branch port part 26a and the region 26c1 located upstream of the first branch port part 26a. However, a region at which a water jacket is arranged in the engine 110 in which the SCV 112 is provided on the upstream side of the branch point P1 may also be either one of the first branch port part 26a and the region 26c1.

The foregoing first embodiment and the like is described taking the SCV 30 or SCV 112 as an example of a swirl control device. However, a swirl control device that is an object of the present application is not limited to a device that utilizes a swirl control valve, and for example may be the device described in the following. That is, a variable valve train is known which is configured so that a second intake valve that opens and closes a second branch port part can perform opening/closing actions while a first intake valve that opens and closes a first branch port part is maintained in a closed state. Strengthening of a swirl flow may be realized by stopping (restricting) an inflow of intake air to the combustion chamber from the first branch port part by using this kind of variable valve train.

Further, in the above described first embodiment and the like, as shown in FIG. 1, the LT cooling water circulation system 16 through which LT cooling water of a relatively low temperature flows includes the first LT cooling water channel 20 that is formed inside the cylinder head 14, and the second LT cooling water channel 22 that is formed inside the cylinder block 12. However, a low-temperature cooling water channel of the low-temperature cooling water circulation system in the present application may be formed in only the cylinder head 14. Further, introduction of LT cooling water to the engine in the low-temperature cooling water circulation system may be performed in a manner in which the LT cooling water is not introduced into the cylinder head first, but rather is first introduced into the cylinder block.

Furthermore, in the above described first embodiment and the like, the intake port 26 in which a single first branch port part 26a and a single second branch port part 26b are connected to the common combustion chamber 40 is described as an example. However, in the present application, the number of first branch port parts that are connected to the common combustion chamber may be more than one, and similarly the number of second branch port parts connected to the common combustion chamber may also be more than one.

1. An internal combustion engine, comprising:
a low-temperature cooling water circulation system that is one of two cooling water circulation systems in which temperatures of cooling water are different, and that includes a low-temperature cooling water channel formed in an internal combustion engine, and that is configured to causes cooling water of a low temperature to circulate in the low-temperature cooling water channel;
a high-temperature cooling water circulation system that is one of the two cooling water circulation systems, and that includes a high-temperature cooling water channel formed in the internal combustion engine, and that configured to cause cooling water of a high temperature to circulate in the high-temperature cooling water channel;
an intake port including a first branch port part and a second branch port part that are connected to a common combustion chamber; and
a swirl control device configured to restrict an inflow of intake air from the first branch port part to the combustion chamber to increase a strength a swirl flow generated inside a cylinder,
wherein the low-temperature cooling water channel includes a water jacket that is arranged so as to cover a part of a periphery of the intake port when the intake port is viewed at a cross section that is perpendicular to a central trajectory of the intake port, and
wherein the water jacket is arranged so that, when the intake port is viewed at the cross section, the water jacket covers a periphery of a region in which an intake air flow rate inside the intake port becomes relatively smaller or a region in which intake air does not flow, when an inflow of intake air to the combustion chamber from the first branch port part is restricted by the swirl control device.

2. The internal combustion engine according to claim 1, further comprising an exhaust gas recirculation passage through which recirculated exhaust gas that returns from an exhaust passage to an intake passage flows,
wherein the exhaust gas recirculation passage is connected to the second branch port part.

3. The internal combustion engine according to claim 1, further comprising a blow-by gas return passage through which blow-by gas that returns to an intake passage flows,
wherein the blow-by gas return passage is connected to the second branch port part.

4. The internal combustion engine according to claim 1,
wherein the water jacket is formed so as to cover a periphery of the first branch port part.
